(19) United States
(12) Patent Application Publication
(10) Pub. No.: US 2005/0278242 A1
(43) Pub. Date: Dec. 15, 2005

(54) System, apparatus and method for performing a trailing stop investment transaction

(75) Inventors: John Dankovchik, Plano, TX (US); Bud Griffin, Flower Mound, TX (US)

Correspondence Address: CHALKER FLORES, LLP, 12700 PARK CENTRAL, STE. 455, DALLAS, TX, 75251, US

(73) Assignee: GlobalTec Solutions, LLP, Addison, TX (US)

(21) Appl. No.: 10/866,440

(22) Filed: Jun. 12, 2004

(51) Int. Cl. G06F 17/60

(52) U.S. Cl. 705/37

(57) ABSTRACT

The present invention provides a system, apparatus and method for performing a buy/sell side trailing stop transaction by: (a) receiving a transaction request for an investment containing a target price, a stop price and a trail amount for an investment, (b) obtaining an ask/bid/last price for the investment, (c) determining whether the ask/bid/last price is less/greater than or equal to the target price, (d) whenever the ask/bid/last price is less/greater than or equal to the target price, setting the stop price equal to the ask/bid/last price plus/minus the trail amount and repeating steps (b)-(e), and (e) whenever the ask/bid/last price is greater/less than the target price, determining whether the ask/bid/last price is greater/less than or equal to the stop price, repeating steps (b)-(e) whenever the ask/bid/last price is less/greater than the stop price, submitting a buy/sell order whenever the ask/bid/last price is greater/less than or equal to the stop price.

### FIELD OF THE INVENTION

The present invention relates in general to the field of computer software and more particularly to a system, apparatus and method for performing a trailing stop investment transaction.

### BACKGROUND OF THE INVENTION

With the advent of electronic trading, it is more critical than ever to make appropriate entry and exit decisions quickly to maximize profits while minimizing losses. This is especially true with day trading. Yet with the many technological advances in investment analysis tools, investment orders or trades have remained relatively unchanged. In fact, a number of investor trading methods require the investor to submit and cancel numerous orders as they ride an investment trend. Moreover, current trade execution systems prevent the investor from being “creative” in their trades or implementing any type of complex trading strategy. As a result, an investor must constantly monitor the market and/or investment after an order has been placed to guard against a turn in the market or cancel the order to take advantage of an opportunity.

Attempts have been made to solve these problems. For example, U.S. Patent Publication 20020004776 proposes an automated trading system that requires a user to input trigger criteria and account information into sophisticated market analysis software, which in turn monitors changes in market data and outputs a trade decision. The trade decision is then sent to an on-line trading account, which in turn submits a trade order. This system requires both the market analysis software and the on-line trading software. Moreover, the user must be well versed in the filtering criteria of the market analysis software in order to set up the user's trading plan. For most investors, even sophisticated investors, the complexity of such a system and the idea of having a computer automatically executing a trading plan are far too risky. In addition, a good investor relies on more than just a preprogrammed plan to make money in a market. As a result, such an automated trading system does not provide an investor with an easy to use system that will interface with current systems and does not require the use sophisticated market analysis software to interface with an on-line trading account.

There is, therefore, a need for a system, apparatus and method for performing a trailing stop investment transaction, which reduces the risk and loss for the investor, saves the investor time and can be managed without investor control.

### SUMMARY OF THE INVENTION

The present invention provides a system, apparatus and method for performing a trailing stop investment transaction. Using the present invention, anyone interested in investments, such as individual investors or investment brokers, can create, customize and submit complex investment orders having multiple conditions from their home, office or location of their choice without having to constantly monitor the status of such orders. As a result, the present invention reduces the risk and loss for the investor and saves the investor time.

In one embodiment, the present invention provides a system, apparatus and method for initiation of investment transactions based upon the value of a security held by the investor or trader reaching a predetermined amount (set value, change or percentage change), followed by the unattended execution of the transaction determined by transitions in the value of the security. The trader of the security transmits the order to an intermediary system and identifies the order transmitted as being unique from standard security transactions by specifying an order type indicating that the order should not be processed for execution until one or more non-time-based conditions related to a security are met. The conditions are typically based on the value of the security, such as a current ask price, current bid price, current last price, target price, etc. The conditions may also include changes in the value of the security, such as a currency amount change or percentage change, etc.

In addition, the present invention provides a method for performing a multiple condition investment transaction by: (a) receiving a transaction request for an investment containing two or more non-time-based conditions, each non-time-based condition having an action to be performed whenever the non-time-based condition is satisfied, (b) obtaining market information for the investment, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied.

The transaction request may include a buy-side trailing stop order, a sell-side trailing stop order or other user customized multiple condition order. The investment can be a stock, a bond, a mutual fund, a commodity, an option, a foreign currency pair or other investment traded electronically in a market. Typically, the non-time-based condition will include a target price, a stop price, a price change, a trading volume or a trailing amount. The action associated with the non-time-based condition can be an instruction to cancel the request, submit an order for the investment, or modify one or more of the non-time-based conditions. The transaction request may also include one or more time-based conditions having an associated action to cancel the request or submit an order.

The present invention also provides a method for performing a sell-side trailing stop transaction by: (a) receiving a transaction request for an investment containing a target price, a stop price and a trail amount for an investment, (b) obtaining a current bid price for the investment, (c) determining whether the current bid price is greater than or equal to the target price, (d) whenever the current bid price is greater than or equal to the target price, setting the stop price equal to the current bid price minus the trail amount and repeating steps (b) through (e), and (e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price. In one embodiment, the stop price is not set equal to the current bid price minus the trail amount when the current bid price minus the trail amount is greater than the stop price. Alternatively, the present invention can use a last price instead of the current bid price.

Similarly, the present invention provides a method for performing a buy-side trailing stop transaction by: (a) receiving a transaction request for an investment containing a target price, a stop price and a trail amount for an investment, (b) obtaining a current ask price for the investment, (c) determining whether the current ask price is less than or equal to the target price, (d) whenever the current ask price is less than or equal to the target price, setting the stop price equal to the current ask price plus the trail amount and repeating steps (b) through (e), and (e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price. In one embodiment, the stop price is not set equal to the current ask price plus the trail amount when the current ask price plus the trail amount is less than the stop price. Alternatively, the present invention can use a last price instead of the current ask price.

Moreover, the present invention provides an apparatus for performing a multiple condition investment transaction that includes one or more market communication interfaces and a processor communicably coupled to the one or more market communication interfaces. The processor performs the following steps: (a) receiving a transaction request for an investment containing two or more non-time-based conditions, each non-time-based condition having an action to be performed whenever the non-time-based condition is satisfied, (b) obtaining market information for the investment from a market via the one or more market communication interfaces, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied. The apparatus may also include one or more client communication interfaces communicably coupled to the processor.

In addition, the present invention provides an apparatus for performing a sell-side trailing stop transaction that includes one or more market communication interfaces communicably coupled to one or more markets and a processor communicably coupled to the one or more market communication interfaces. The processor performs the following steps: (a) receiving a transaction request for an investment containing a target price, a stop price and a trail amount for an investment, (b) obtaining a current bid price for the investment, (c) determining whether the current bid price is greater than or equal to the target price, (d) whenever the current bid price is greater than or equal to the target price, setting the stop price equal to the current bid price minus the trail amount and repeating steps (b) through (e), and (e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price. In one embodiment, the stop price is not set equal to the current bid price minus the trail amount when the current bid price minus the trail amount is greater than the stop price. Alternatively, the present invention can use a last price instead of the current bid price.

Similarly, the present invention provides an apparatus for performing a buy-side trailing stop transaction that includes one or more market communication interfaces and a processor communicably coupled to the one or more market communication interfaces. The processor performs the following steps: (a) receiving a transaction request for an investment containing a target price, a stop price and a trail amount for an investment, (b) obtaining a current ask price for the investment, (c) determining whether the current ask price is less than or equal to the target price, (d) whenever the current ask price is less than or equal to the target price, setting the stop price equal to the current ask price plus the trail amount and repeating steps (b) through (e), and (e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price. In one embodiment, the stop price is not set equal to the current ask price plus the trail amount when the current ask price plus the trail amount is less than the stop price. Alternatively, the present invention can use a last price instead of the current ask price.

Moreover, the present invention provides a system for performing a multiple condition investment transaction that includes one or more markets, one or more networks, a one or more market communication interfaces communicably coupled to one or more markets via the one or more networks and a processor communicably coupled to the first communications interface. The processor performs the following steps: (a) receiving a transaction request for an investment containing two or more non-time-based conditions, each non-time-based condition having an action to be performed whenever the non-time-based condition is satisfied, (b) obtaining market information for the investment from the market via the one or more market communication interfaces, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied.

In addition, the present invention provides a system for performing a multiple condition investment transaction that includes one or more markets, one or more networks, one or more market communication interfaces communicably coupled to one or more markets via the one or more networks and a processor communicably coupled to the one or more market communications interfaces. The processor performs the following steps: (a) receiving a transaction request for an investment containing a target price, a stop price and a trail amount for an investment, (b) obtaining a current bid price for the investment, (c) determining whether the current bid price is greater than or equal to the target price, (d) whenever the current bid price is greater than or equal to the target price, setting the stop price equal to the current bid price minus the trail amount and repeating steps (b) through (e), and (e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price. In one embodiment, the stop price is not set equal to the current bid price minus the trail amount when the current bid price minus the trail amount is greater than the stop price. Alternatively, the present invention can use a last price instead of the current bid price.

Similarly, the present invention provides a system for performing a multiple condition investment transaction that includes one or more markets, one or more networks, one or more market communication interfaces communicably coupled to one or more markets via the one or more networks and a processor communicably coupled to the one or more market communication interfaces. The processor performs the following steps: (a) receiving a transaction request for an investment containing a target price, a stop price and a trail amount for an investment, (b) obtaining a current ask price for the investment, (c) determining whether the current ask price is less than or equal to the target price, (d) whenever the current ask price is less than or equal to the target price, setting the stop price equal to the current ask price plus the trail amount and repeating steps (b) through (e), and (e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price. In one embodiment, the stop price is not set equal to the current ask price plus the trail amount when the current ask price plus the trail amount is less than the stop price. Alternatively, the present invention can use a last price instead of the current ask price.

Other features and advantages of the present invention will be apparent to those of ordinary skill in the art upon reference to the following detailed description taken in conjunction with the accompanying drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts in which:

FIG. 1 is a block diagram illustrating the possible interaction between data systems in accordance with one embodiment of the present invention;

FIG. 2 is a block diagram illustrating information flow between various entities in accordance with one embodiment of the present invention;

FIG. 3 is a flow chart illustrating a method of performing a multiple condition investment transaction in accordance with one embodiment of the present invention;

FIGS. 4A, 4B and 4C are flow charts illustrating a method of performing a multiple condition investment transaction in accordance with another embodiment of the present invention;

FIGS. 5A and 5B are graphs illustrating an example of a sell side and buy side trailing stop order in accordance with one embodiment of the present invention;

FIG. 6 is a client side entry form for performing a trailing stop order in accordance with one embodiment of the present invention;

FIG. 7 is a flow chart illustrating a trailing stop order submission process in accordance with one embodiment of the present invention;

FIG. 8 is a flowchart illustrating a trailing stop order execution process in accordance with one embodiment of the present invention;

FIG. 9 is a flowchart illustrating a trailing stop order execution process in accordance with another embodiment of the present invention;

FIG. 10 is a block diagram illustrating an apparatus in accordance with one embodiment of the present invention; and

FIG. 11 is a block diagram illustrating a system in accordance with one embodiment of the present invention.

### DETAILED DESCRIPTION OF THE INVENTION

It should be understood that the principles and applications disclosed herein can be applied to a wide range of investment trading scenarios, such as stocks, bonds, mutual funds, commodities, options, foreign exchange currency pairs, etc. For purposes of explanation and illustration, the present invention is hereafter described in reference to the initiation, processing and submission of investment orders. The present invention allows anyone interested in investments, such as individual investors or investment brokers, to create, customize and submit complex investment orders having multiple conditions from their home, office or location of their choice without having to constantly monitor the status of such orders. As a result, the present invention reduces the risk and loss for the investor, saves the investor time, and can be managed without investor control.

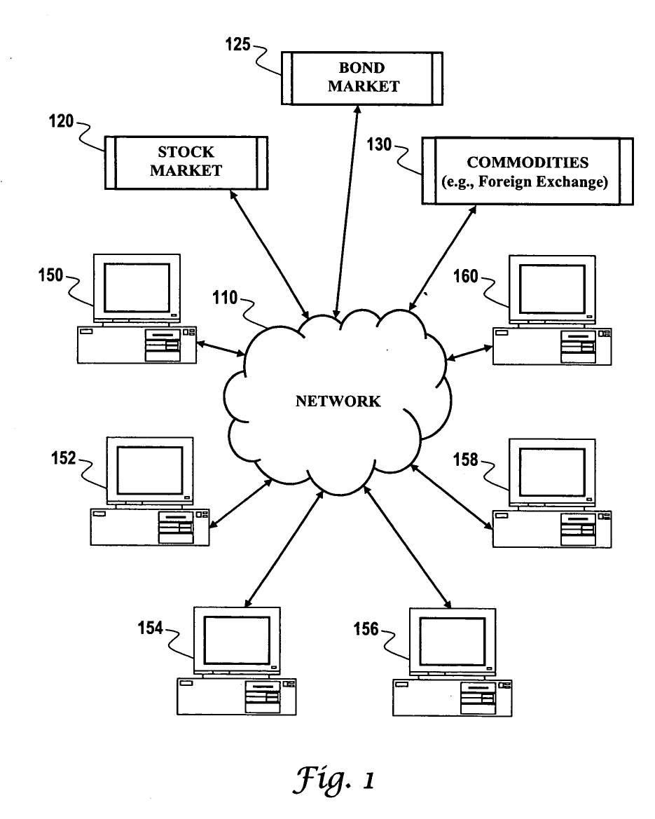

Now referring to FIG. 1, a block diagram illustrating the possible interaction between data systems in accordance with one embodiment of the present invention is shown. Investors or client applications 150, 152, 154, 156, 158 and 160 interact with the various investment markets (Stocks) 120, (Bonds) 125 and (Commodities (e.g., foreign exchange)) 130 via one or more networks 110, which may comprise any typical communications network such as telephone, Internet, satellite, wireless or any combination thereof. Access to the market information sources or markets 120, 125 and 130 can be achieved through a service specific to each market, or through a third-party server that will allow access to one or more of the markets 120, 125 or 130. Investors 150, 152, 154, 156, 158 and 160 can access the network 110 using a personal computer, workstation or laptop computer. The present invention is preferably a server-based application accessible by investors 150-160 via a network or other communications link. In some cases, the present invention can be implemented as an application on each investor's computer 150-160. Although the processing power of a computer is typically required to analyze the market data, a multiple condition order in accordance with the present invention can be submitted by the investor 150-160 to the server or operator of the server using a telephone, mobile communications device, personal data assistant (“PDA”), facsimile, verbal communication or other communication means. The number of investors 150, 152, 154, 156, 158 and 160 shown in FIG. 1 is simply representative and does not indicate a limitation on the number of investors that may use the present invention at a given time. Nor is the number of investment types or markets 120, 125 and 130 intended to limit the number or types of investments that may analyzed with the present invention.

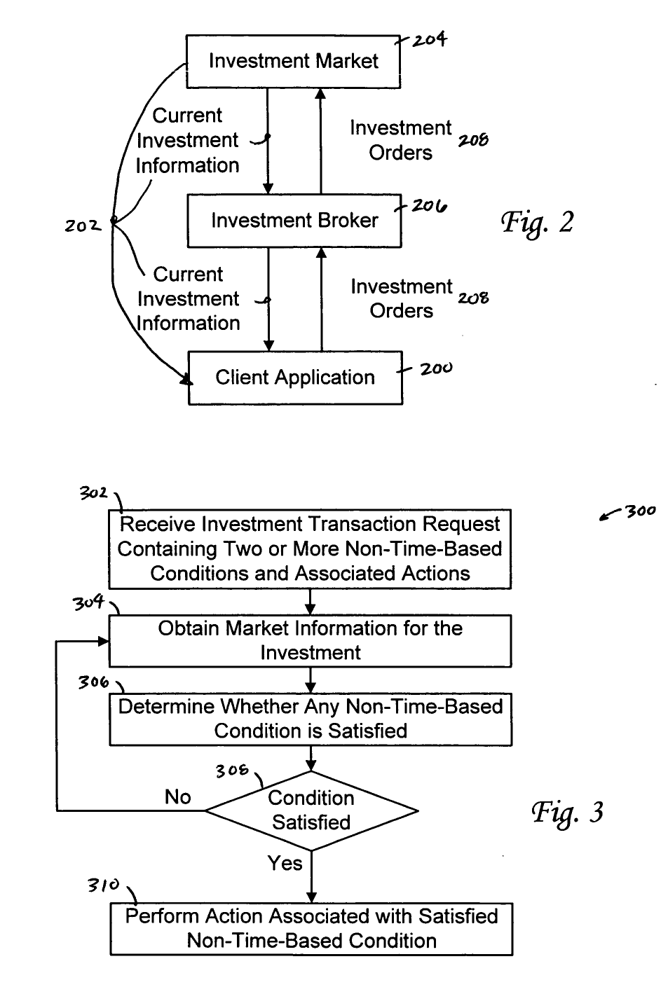

Referring now to FIG. 2, a block diagram illustrating information flow between various entities in accordance with one embodiment of the present invention is shown. A client application 200 can obtain current investment information 202 directly from an investment market 204 or via an investment broker 206 (intermediary system). The client application 200 runs investment analysis and trading software that is provided by the investment broker 206 or a third party. The investor or client runs the client application 200 on his or her computer in either a stand alone mode or a client server mode. Once an investor decides to purchase or sell an investment, he or she places an order 208 with the investment broker 206. The order can be delivered to the investment broker 206 via the client application 200 or other means, such as verbally, written, electronic mail, personal data assistant (“PDA”) or other communications device. The investment broker 206 is then responsible for executing the order 208 in accordance with the parameters set forth in the order 208. The investment broker 206 can execute the order 208 directly with the investment market 204 or through one or more intermediate entities (not shown).

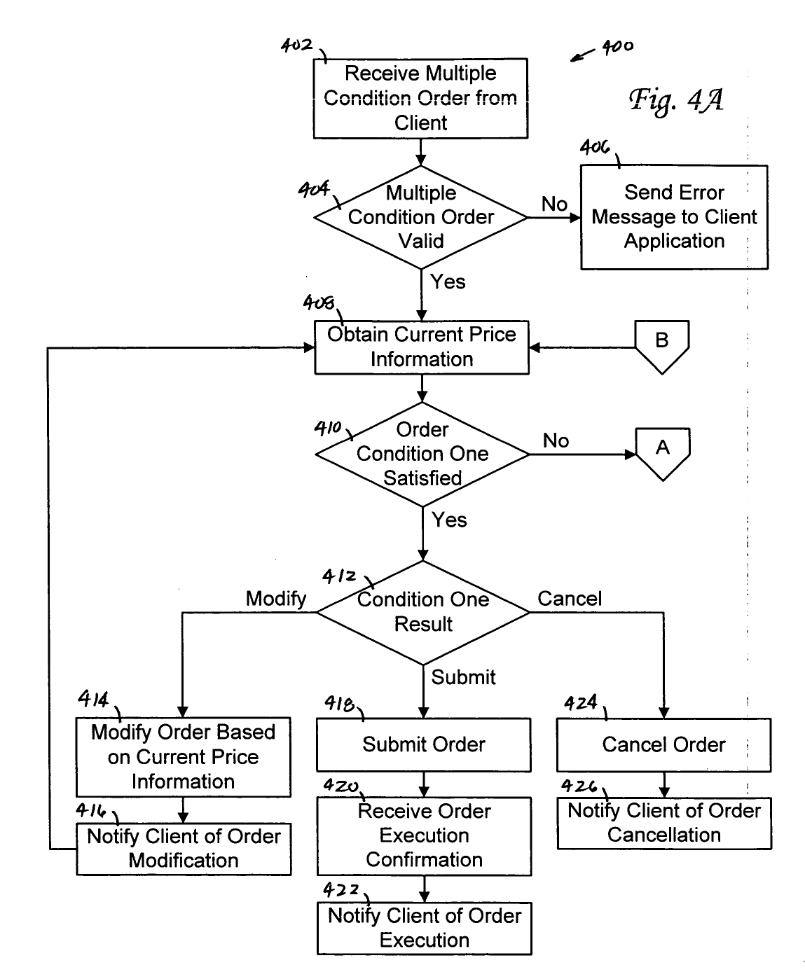

Now referring to FIG. 3, a flow chart illustrating a method 300 of performing a multiple condition investment transaction in accordance with one embodiment of the present invention is shown. The process starts when a transaction request for an investment is received that contains two or more non-time-based conditions in block 302. Typically, this process is initiated when an order is received that contains a flag or other indication that the order is not a standard investment transaction in that it specifies an order type indicating that this order should not be processed for execution until one or more conditions of a multiple condition order relating to an investment are satisfied. The transaction request may be made up of one or more transaction messages that include a buy-side trailing stop order, a sell-side trailing stop order or other user customized multiple condition order. The transaction request can be created from one or more inputs provided by a user, e.g. data from fill-in fields, point-and-click operations, drop-down menus, verbal commands, macros or any combination thereof. Moreover the transaction request can be received via a client application or other means, such as verbally, written, electronic mail, personal data assistant (“PDA”) or other communications device. In addition, the transaction request may include a quantity of the investment, a buy or sell indication, account information, user information, etc. The investment can be a stock, a bond, a mutual fund, a commodity, an option, a foreign currency pair or other investment traded electronically in a market.

Typically, the non-time-based condition will include a target price, a stop price, a price change (currency amount per unit or percentage of value), a trading volume or a trailing amount. Each non-time-based condition has a corresponding action to be performed whenever the non-time-based condition is satisfied. The action associated with the non-time-based condition can be an instruction to cancel the request, submit an order for the investment, or modify one or more of the non-time-based conditions. For example, the non-time-based condition can be a current price for the investment crosses a target price and the associated action sets a stop price based on the current price and a trail amount. The current price can be set by the client or the server to be an asking price, a bid price, a last price, an opening price or a closing price. Similarly, the non-time-based condition can be a current price for the investment crossing a stop price and the associated action submits a market order or a limit order for the investment. The two or more non-time-based conditions can be formatted or entered to represent a Boolean formula. Moreover, the non-time-based conditions and their associated actions can be formatted or entered as one or more logical expressions. Note that the transaction request may also include one or more time-based conditions having an associated action to cancel the request or submit an order within a specified time period, such as time certain, time from order, time before market close, market close, days, weeks, etc.

Market information for the investment is then obtained from a source of market information in block 304. The market information may include an asking price, a bid price, a price change, an opening price, a closing price, a trading volume, etc. A determination is then made whether or not any of the two or more non-time-based conditions are satisfied based on the market information in block 306. If none of the two or more non-time-based conditions are satisfied, as determined in decision block 308, the process loops back to block 304 and obtains market information for the investment and again determines whether or not any of the non-time-based conditions are satisfied in block 306. If, however, any of the non-time-based conditions are satisfied, as determined in decision block 308, the action associated with each non-time-based condition that is satisfied is performed in block 310. Depending on the implementation of the present invention, the process may then loop back to block 304 after completion of block 310 if the actions performed do not cancel the transaction request or submit an order for the investment, or the actions performed modifies one or more of the non-time-based conditions. Other optional steps may include validating the transaction request, sending an acknowledgment that the transaction request has been successfully received, requesting confirmation of the transaction request, sending a notification of the action taken to an originator of the transaction request, or waiting for a specified period of time before performing obtaining the market information in block 304. The present invention, therefore, provides unattended execution of a multiple condition investment transaction.

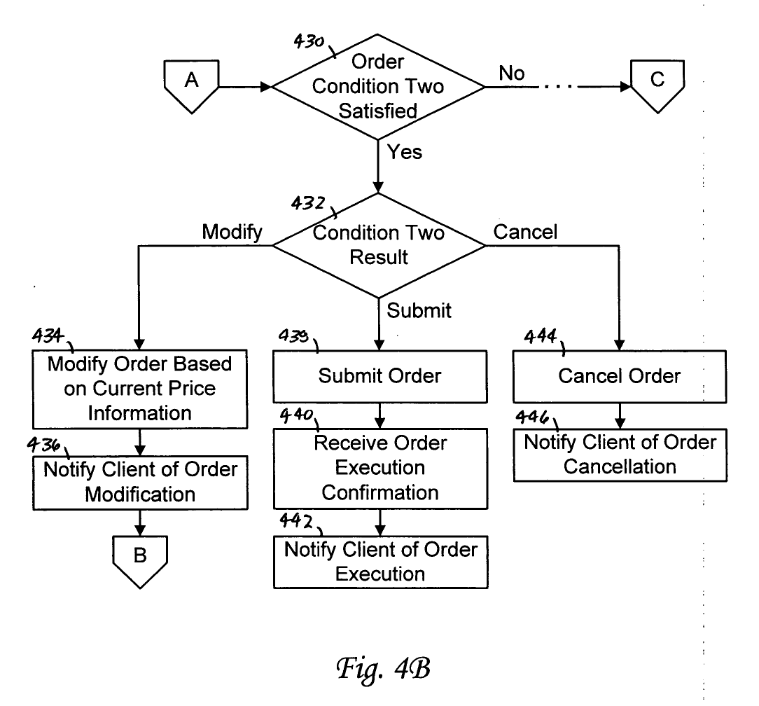

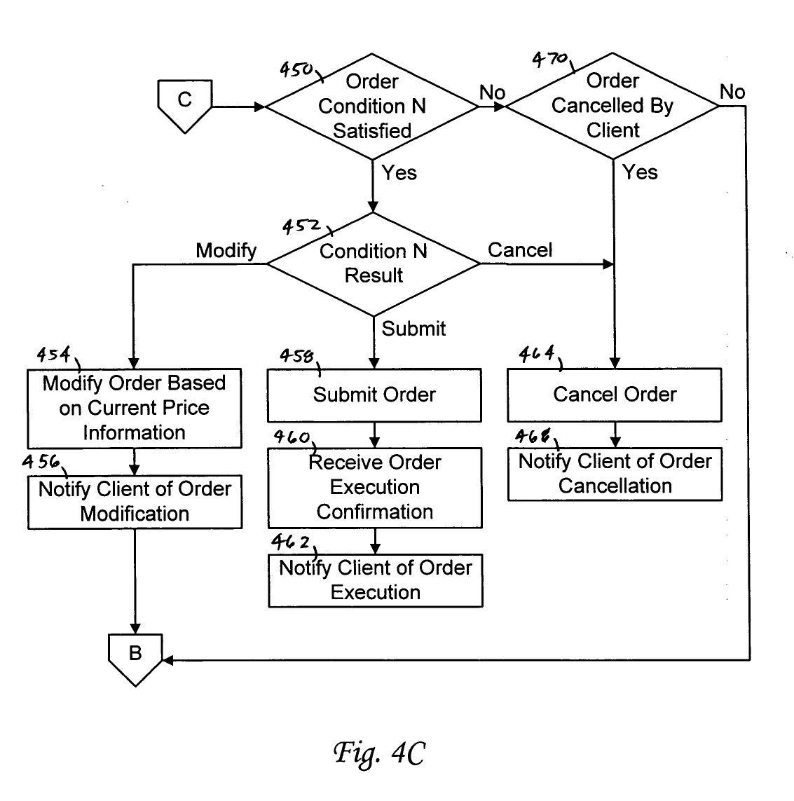

Referring now to FIGS. 4A, 4B and 4C, flow charts illustrating a method 400 of performing a multiple condition investment transaction in accordance with another embodiment of the present invention is shown. The process starts when a multiple condition order is received from a client in block 402. As used herein, a multiple condition order is a transaction request for an investment that contains two or more non-time-based conditions. The order will typically use standard protocols and have a flag or other indication that the order is not a standard investment transaction in that it specifies an order type indicating that this order should not be processed for execution until one or more conditions of a multiple condition order relating to an investment are satisfied. The multiple condition order may be made up of one or more transaction messages that include a buy-side trailing stop order, a sell-side trailing stop order or other user customized multiple condition order. The transaction request can be created from one or more inputs provided by a user, e.g. data from fill-in fields, point-and-click operations, drop-down menus, verbal commands, macros or any combination thereof. Moreover the multiple condition order can be received via a client application or other means, such as verbally, written, electronic mail, personal data assistant (“PDA”) or other communications device. In addition, the multiple condition order may include a quantity of the investment, a buy or sell indication, account information, user information, etc. The investment can be a stock, a bond, a mutual fund, a commodity, an option, a foreign currency pair or other investment traded electronically in a market.

Typically, the non-time-based condition will include a target price, a stop price, a price change (currency amount per unit or percentage of value), a trading volume or a trailing amount. Each non-time-based condition has a corresponding action to be performed whenever the non-time-based condition is satisfied. In this embodiment, the action associated with the non-time-based condition can be an instruction to cancel the request, submit an order for the investment, or modify one or more of the non-time-based conditions. For example, the non-time-based condition can be a current price for the investment crosses a target price and the associated action sets a stop price based on the current price and a trail amount. The current price can be set by the client or the server to be an asking price, a bid price, a last price, an opening price or a closing price. Similarly, the non-time-based condition can be a current price for the investment crossing a stop price and the associated action submits a market order or limit order for the investment. The two or more non-time-based conditions can formatted or entered to represent a Boolean formula. Moreover, the non-time-based conditions and their associated actions can be formatted or entered as one or more logical expressions. Note that the multiple condition order may also include one or more time-based conditions having an associated action to cancel the request or submit an order within a specified time period, such as time certain, time from order, time before market close, market close, days, weeks, etc.

If the multiple condition order is not valid, as determined in decision block 404, an error message is sent to the client application in block 406. If, however, the multiple condition order is valid, as determined in decision block 404, market information for the investment is then obtained from a source of market information in block 408. The market information is typically obtained through a request/response process, a data query or an automatic update process. The market information may include an asking price, a bid price, a last price, a price change, an opening price, a closing price, a trading volume, etc. A determination is then made whether or not any of the two or more non-time-based conditions are satisfied based on the market information. If order condition one is satisfied, as determined in decision block 410, the action or result associated with condition one is performed. If the action or result is to modify the order, as determined in decision block 412, the order is modified based on the market information in block 414, the client is notified of the order modification in block 416 and the process loops back to block 408 to obtain current market information. Alternatively, the process can continue to check the other conditions before looping back to obtain current market information. If the action or result is to submit an order, as determined in decision block 412, the order is submitted or executed in block 418, an order execution confirmation is received in block 420 and the client is notified of the order execution in block 422. If the action or result is to cancel the order, as determined in decision block 412, the order is cancelled in block 424 and the client is notified of the order cancellation in block 426.

If, however, order condition one is not satisfied, as determined in decision block 410, and order condition two is satisfied, as determined in decision block 430, the action or result associated with condition two is performed. If the action or result is to modify the order, as determined in decision block 432, the order is modified based on the market information in block 434, the client is notified Of the order modification in block 436 and the process loops back to block 408 to obtain current market information. Alternatively, the process can continue to check the other conditions before looping back to obtain current market information. If the action or result is to submit an order, as determined in decision block 432, the order is submitted or executed in block 438, an order execution confirmation is received in block 440 and the client is notified of the order execution in block 442. If the action or result is to cancel the order, as determined in decision block 432, the order is cancelled in block 444 and the client is notified of the order cancellation in block 446.

If, however, order condition two is not satisfied, as determined in decision block 430, and order condition N (indicating that there can be N number of conditions) is satisfied, as determined in decision block 450, the action or result associated with condition N is performed. If the action or result is to modify the order, as determined in decision block 452, the order is modified based on the market information in block 454, the client is notified of the order modification in block 456 and the process loops back to block 408 to obtain current market information. Alternatively, the process can continue to check the other conditions before looping back to obtain current market information. If the action or result is to submit an order, as determined in decision block 452, the order is submitted or executed in block 458, an order execution confirmation is received in block 460 and the client is notified of the order execution in block 462. If the action or result is to cancel the order, as determined in decision block 452, the order is cancelled in block 464 and the client is notified of the order cancellation in block 466. If, however, order condition N is not satisfied as determined in decision block 450 and the order has not been cancelled by the client, as determined in decision block 470, the process loops back to block 408 to obtain current market information. If, however, order condition N is not satisfied as determined in decision block 450 and the order has been cancelled by the client, as determined in decision block 470, the order is cancelled in block 464 and the client is notified of the order cancellation in block 466. The present invention, therefore, provides unattended execution of a multiple condition investment transaction.

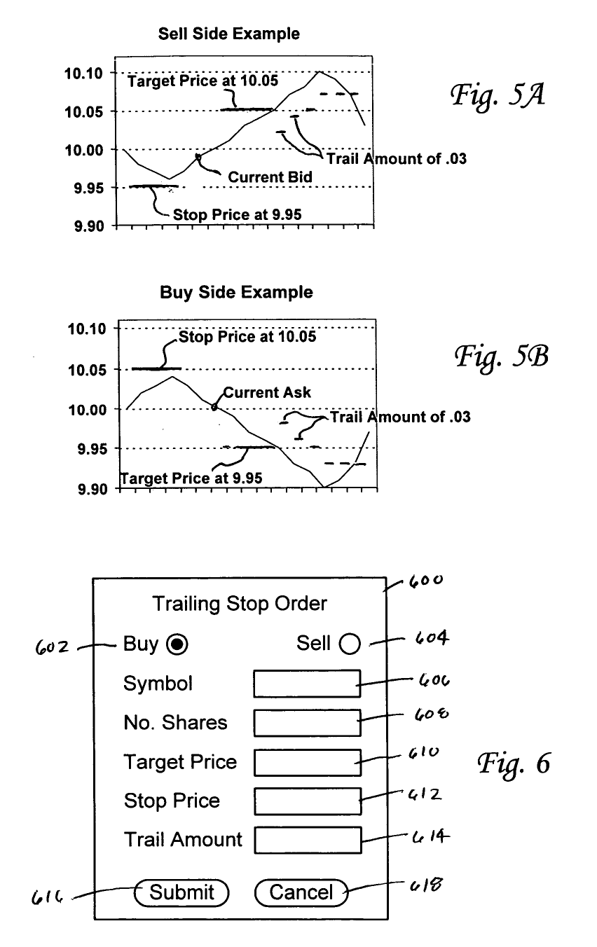

Now referring to FIGS. 5A and 5B, graphs illustrating an example of a sell side and buy side trailing stop order in accordance with one embodiment of the present invention are shown. The present invention allows a buy or sell side order to be sent to and processed by an electronic trading system with an initial Stop Loss Price being the maximum loss allowed for the position. If the price per share meets or crosses the specified Target Price, then treat the order as a trailing stop to be pegged by the specified Trail Amount.

In the Sell Side example (FIG. 5A), the Stop Price is set at 9.95. If the bid price per share meets or drops below this level, the order immediately becomes a market order. If the bid price per share meets or exceeds the Target Price of 10.05, a new stop price is effectively set to the Target Price minus the Trail Amount of 0.03 (10.02 in the example). As long as the price continues to rise the effective stop price will increase, following the bid price by the Trail Amount. Once the bid price per share declines the effective stop price will remain at the highest value (10.07 in the example) and if the bid price meets or drops below the highest effective stop price (10.07 in the example), the order becomes a market order.

In the Buy Side example (FIG. 5B), the Stop Price is set at 10.05. If the ask price per share meets or exceeds this level, the order immediately becomes a market order. If the ask price per share meets or falls below the Target Price of 10.05, a new stop price is effectively set to the Target Price plus the Trail Amount of 0.03 (9.98 in the example). As long as the price continues to drop the effective stop price will decrease, following the ask price by the Trail Amount. Once the ask price per share increases the effective stop price will remain at the lowest value (9.93 in the example) and if the ask price meets or exceeds the lowest effective stop price (9.93 in the example), the order becomes a market order.

The present invention can be implemented using existing trading protocols. No new tags are required to support this feature; all required values are specified using minor variations to existing FIX protocol specifications. Even though trailing stops aren't supported in FIX prior to version 4.4, the proposed implementation can be easily implemented with version 4.1 or later. The trailing stop implementation follows the FIX 4.4 specification for trailing stop orders with the exception of the use of the PegDifference tag (Tag 211). The following defines the FIX tags and values for implementing stop loss with targeted trailing stop:

| FIX Tag | Tag Value & Description |
|---|---|
| OrdType (Tag 40) | ‘P’ = Pegged |
| ExecInst (Tag 18) | ‘a’ = Trailing Stop |
| Price (Tag 44) | Target Price |
| StopPx (Tag 99) | Stop Price |
| PegDifference (Tag 211) | Trail Amount to add/subtract (buy/sell) |
| | from Current Price (bid, ask or last) |

The following pseudo code describes an algorithm that is one possible method for implementing a stop loss with targeted trailing stop orders in accordance with the present invention. The following logic is performed for each change in bid or ask price for the investment. Note that a current ask price or bid price can be used instead of the last price.

If the order is buy side (‘1’) then

If the order type is pegged (‘P’) and exec instructions contain
a trailing stop (‘a’)
then

If last price is less than or equal to target price then

Set target price to last price

Endif
If target price plus trail amount is less than stop price then

Set stop price to target price plus trail amount

EndIf

If last price is greater than or equal to stop price then

Submit order as market order

EndIf

EndIf
If the order is sell side (‘2’) then

If the order type is pegged (‘P’) and exec instructions contain
a trailing stop (‘a’)
then

If last price is greater than or equal to target price then

Set target price to last price

Endif
If target price minus trail amount is greater than stop
price then

Set stop price to target price minus trail amount

EndIf

If last price is less than or equal to stop price then

Submit order as market order

EndIf

EndIf

Referring now to FIG. 6, a client side entry form 600 for performing a trailing stop order in accordance with one embodiment of the present invention is shown. The trailing stop order entry screen or form 600 includes a buy/sell indicator, e.g. buy radio button 602 and sell radio button 604, symbol entry field 606, number of shares entry field 608, target price entry field 610, stop price entry field 612, trail amount entry field 614, submit button 616 and cancel button 618. Other entry fields can be used to provide additional conditions and actions, such as a time period for the order to expire (time certain, time from order, time before market close, market close, days, weeks, etc.). In addition, other display formats and orientations can be used. For example, a series of drop down menus or a free form text field can be used to create a Boolean expression of multiple conditions having associated actions.

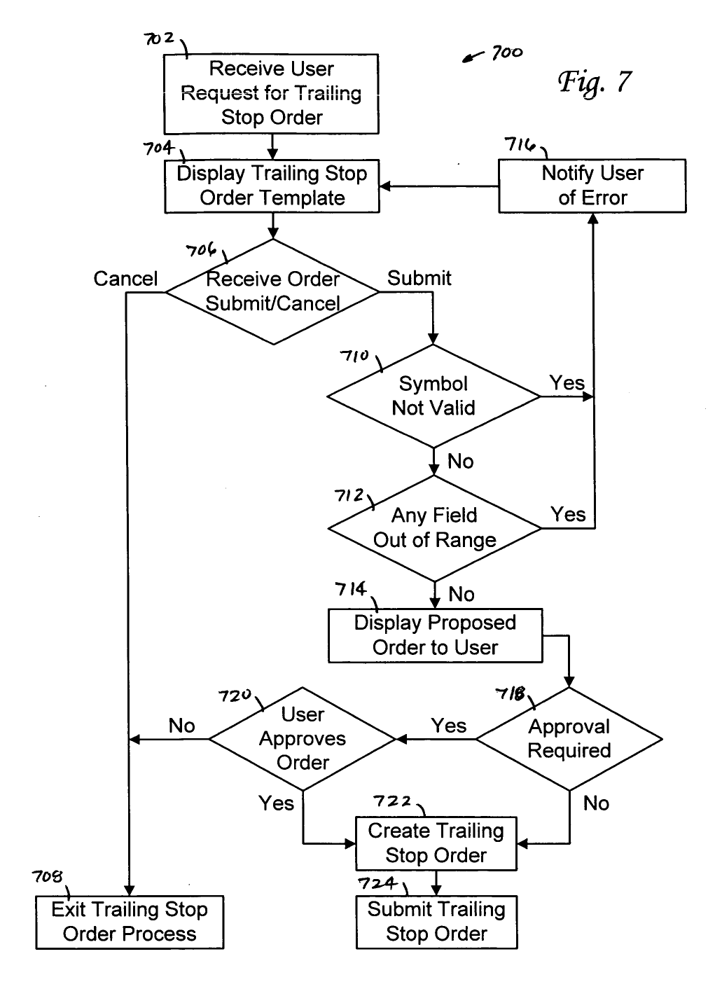

Now referring to FIG. 7, a flow chart illustrating a trailing stop order submission process 700 in accordance with one embodiment of the present invention is shown. This process 700 can be performed using client side software or server side software via a network. A user request for a trailing stop order is received in block 702 and a trailing stop order template, such as the form depicted in FIG. 6, is displayed in block 704. If the user cancels the order, as determined in decision block 706, the trailing stop order process is exited in block 708. If, however, the user submits the order, as determined in decision block 706, the symbol is valid, as determined in decision block 710 and all the fields are within acceptable ranges, as determined in decision block 712, the proposed order is displayed to the user in block 714. If, however, the symbol is not valid, as determined in decision block 710, or any entry field is out of range, as determined in decision block 712, the user is notified of the error in block 716 and the template is redisplayed to the user in block 704. After the order has been displayed to user in block 714, if user approval is required, as determined in decision block 718, and if the user does not approve the order, as determined in decision block 720, the trailing stop order process is exited in block 708. If, however, user approval is not required, as determined in decision block 718, or the user approves the order, as determined in decision block 720, the trailing stop order is created using the appropriate protocol in block 722 and the trailing stop order is submitted in block 724.

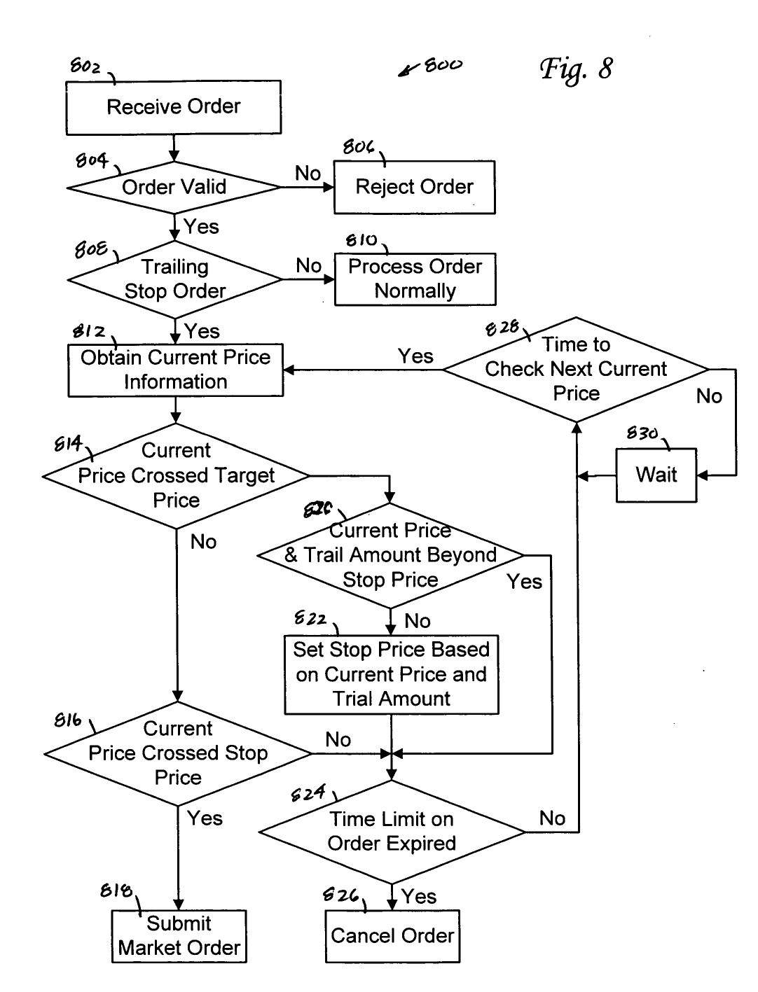

Referring now to FIG. 8, a flowchart illustrating a trailing stop order execution process 800 in accordance with one embodiment of the present invention is shown. An order for an investment is received in block 802. If the order is not valid, as determined in decision block 804, the order is rejected in block 806. If the order is valid, as determined in decision block 804, and the order is not a trailing stop order, as determined in decision block 808, the order is processed normally in block 810. If, however, the order is a trailing stop order for an investment, which typically contains a target price, a stop price and a trail amount for an investment, as determined in decision block 808, current price information for the investment is obtained in block 812. The current price information is typically obtained through a request/response process, a data query or an automatic update process. Moreover, the current price information may include an ask price, a bid price or a last price. If the current price has not crossed a target price as determined in decision block 814 and the current price has crossed a stop price, as determined in decision block 816, a market order for the investment is submitted in block 818. If, however, the current price has crossed the target price, as determined in decision block 814, and the current price and the trail amount are not beyond the stop price, as determined in decision block 820, the stop price is set equal to the current price and the trail amount in block 822. Thereafter, or if the current price and trail amount are beyond the stop price, as determined in decision block 820, or the current price has not crossed the stop price, as determined in decision block 816, the time limit on the order is checked in decision block 824. If the time limit has expired, as determined in decision block 824, the order is cancelled in block 826. If, however, the time limit has not expired, as determined in decision block 824, and it is time to check the next current price, as determined in decision block 828 the process returns to block 812 where current price information is obtained and the process continues as previously described. If, however, it is not time to check the next current price, as determined in decision block 828, the process waits until it is time to check the next current price in block 830.

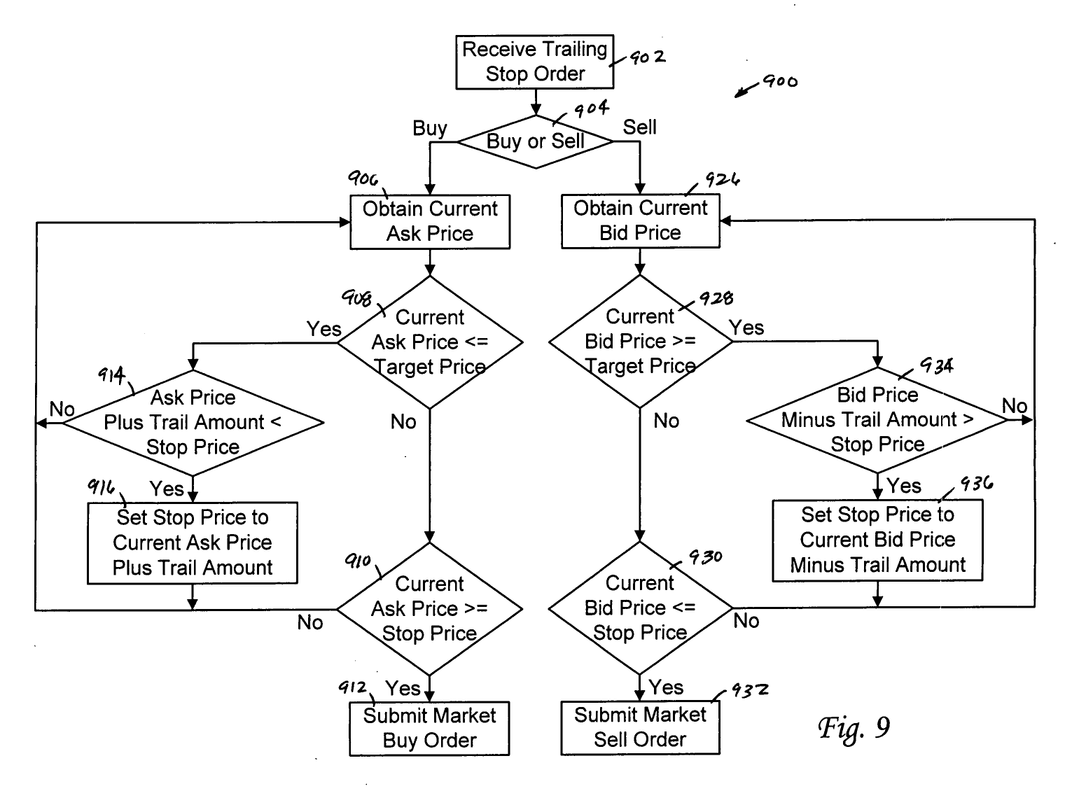

Now referring to FIG. 9, a flowchart illustrating a trailing stop order execution process 900 in accordance with another embodiment of the present invention is shown. The trailing stop order is received in block 902. If the order is a buy-side trailing stop transaction, as determined in decision block 904 a current ask price for the investment is obtained in block 906. The current ask price is typically obtained through a request/response process, a data query or an automatic update process. Note that a last price can be used instead of the current ask price. If the current ask price is greater than the target price, as determined in decision block 908, and the current ask price is greater than or equal to the stop price, as determined in decision block 910, a market buy order is submitted in block 912. If, however, the current ask price is less than or equal to the target price, as determined in decision block 908, and the current ask price plus the trail amount is less than the stop price, as determined in decision block 914, the stop price is set equal to the current ask price plus the trail amount in block 916. Thereafter, or if the current ask price plus the tail amount is not less than the stop price, as determined in decision block 914, or the current ask price is less than the stop price, as determined in decision block 910, the process returns to block 906 where the current ask price is obtained and the process continues as previously described.

If, however, the order is a sell-side trailing stop transaction, as determined in decision block 904 a current bid price for the investment is obtained in block 926. The current bid price is typically obtained through a request/response process, a data query or an automatic update process. Note that a last price can be used instead of the current bid price. If the current bid price is less than the target price, as determined in decision block 928, and the current bid price is less than or equal to the stop price, as determined in decision block 930, a market sell order is submitted in block 932. If, however, the current bid price is greater than or equal to the target price, as determined in decision block 928, and the current bid price minus the trail amount is greater than the stop price, as determined in decision block 934, the stop price is set equal to the current bid price minus the trail amount in block 936. Thereafter, or if the current bid price minus the tail amount is not greater than the stop price, as determined in decision block 934, or the current bid price is greater than the stop price, as determined in decision block 930, the process returns to block 926 where the current bid price is obtained and the process continues as previously described.

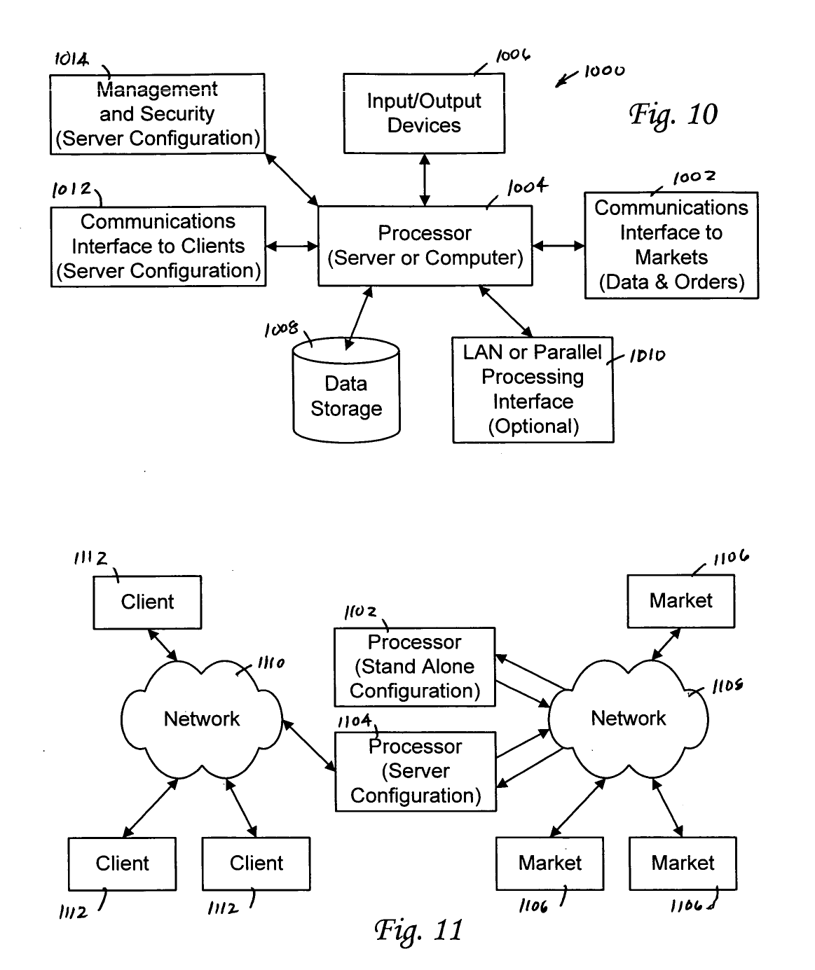

Referring now to FIG. 10, a block diagram illustrating an apparatus 1000 in accordance with one embodiment of the present invention is shown. The apparatus 1000 includes one or more market communication interfaces 1002 (typically an interface for obtaining market data and a separate interface for submitting/processing orders) and a processor 1004 communicably coupled to the one or more market communications interface 1002. The processor 1004 performs the following steps: (a) receiving a transaction request for an investment containing two or more non-time-based conditions, each non-time-based condition having an action to be performed whenever the non-time-based condition is satisfied, (b) obtaining market information for the investment from a market via the one or more market communications interfaces, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied. Alternatively, the processor 1004 can implement any of the methods described herein.

The apparatus 1000 can be operated in a stand alone configuration 1102 (FIG. 11) or in a server configuration 1104 (FIG. 11). In either configuration, the apparatus 1000 may also include one or more input/output devices 1006, such as a display, keyboard, mouse, printer, etc., a data storage unit 1008 or a local area network (“LAN”) or parallel processing interface 1010 communicably coupled to the processor 1004. When operating in a server configuration, the processor 1004 will also be communicably coupled to one or more client communication interfaces 1012 or a management and security system 1014. Other components, modules and devices can be communicably coupled to the processor 1004 to customize the present invention to a particular application.

Now referring to FIG. 11, a block diagram illustrating a system 1100 in accordance with one embodiment of the present invention is shown. The system 1100 can be operated in a stand alone configuration 1102 or in a server configuration 1104. In either configuration, the system 1100 includes one or more markets 1106, one or more networks 1108 and/or 1110, one or more market communication interfaces (included in the processor 1102 or 1104 (see 1002 FIG. 10)) communicably coupled to one or more markets 1106 via the one or more networks 1108, and a processor 1102 or 1104 communicably coupled to the one or more market communications interface (included in the processor 1102 or 1104 (see 1002 FIG. 10)). The two arrows between processors 1102 and 1104 and the one or more networks 1108 indicate separate communication flows for obtaining market data and submitting/processing orders. The processor 1102 or 1104 performs the following steps: (a) receiving a transaction request for an investment containing two or more non-time-based conditions, each non-time-based condition having an action to be performed whenever the non-time-based condition is satisfied, (b) obtaining market information for the investment from a market via the one or more market communications interfaces, (c) determining whether any of the two or more non-time-based conditions are satisfied based on the market information, (d) repeating steps (b) through (e) whenever none of the two or more non-time-based conditions are satisfied, and (e) performing the action associated with each non-time-based condition that is satisfied whenever any of the non-time-based conditions are satisfied. Alternatively, the processor 1102 or 1104 can implement any of the methods described herein. In the server configuration 1104, the system 1100 also includes one or more clients 1112 and one or more client communication interfaces (included in the processor 1104 (see 1012 FIG. 10)) communicably coupled to the processor 1104 and the one or more clients 1112 via the one or more networks 1110.

Although particular embodiments of the present invention have been described in detail, it will be understood by those skilled in the art that various modifications can be made therein without departing from the spirit and scope of the invention as set forth in the appended claims. Moreover, other programs or systems can be created or modified to implement the methods of the present invention. As a result, it is not intended that the present invention be limited to the particular system, apparatus and methods shown in FIGS. 1 through 11.

1. A method for performing a sell-side trailing stop transaction comprising the steps of:
(a) receiving a transaction request for an investment containing a target price, a stop price and a trail amount for an investment;
(b) obtaining a current bid price for the investment;
(c) determining whether the current bid price is greater than or equal to the target price;
(d) whenever the current bid price is greater than or equal to the target price, setting the stop price equal to the current bid price minus the trail amount and repeating steps (b) through (e); and
(e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price.

2. The method as recited in claim 1, wherein the stop price is not set equal to the current bid price minus the trail amount when the current bid price minus the trail amount is greater than the stop price.

3. The method as recited in claim 1, wherein a last price is used instead of the current bid price.

4. The method as recited in claim 1, wherein the investment comprises a stock, a bond, a mutual fund, a commodity, an option or a currency pair.

5. The method as recited in claim 1, wherein the transaction request further comprises a time-based condition having an associated action to cancel the request.

6. The method as recited in claim 1, wherein the transaction request comprises one or more transaction messages.

7. The method as recited in claim 1, wherein the transaction request is created from one or more inputs provided by a user.

8. The method as recited in claim 7, wherein the one or more inputs include data from fill-in fields, point-and-click operations, drop-down menus, verbal commands, macros or any combination thereof.

9. The method as recited in claim 1, further comprising the step of validating the transaction request.

10. The method as recited in claim 1, further comprising the step of sending a notification that the market or limit sell order has been submitted.

11. The method as recited in claim 1, further comprising the step of waiting for a specified period of time before repeating steps (b) through (e).

12. The method as recited in claim 1, wherein the transaction request further comprises a quantity of the investment, a buy or sell indication, account information or user information.

13. A method for performing a buy-side trailing stop transaction comprising the steps of:
(a) receiving a transaction request for an investment containing a target price, a stop price and a trail amount for an investment;
(b) obtaining a current ask price for the investment;
(c) determining whether the current ask price is less than or equal to the target price;
(d) whenever the current ask price is less than or equal to the target price, setting the stop price equal to the current ask price plus the trail amount and repeating steps (b) through (e); and
(e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price.

14. The method as recited in claim 13, wherein the stop price is not set equal to the current ask price plus the trail amount when the current ask price plus the trail amount is less than the stop price.

15. The method as recited in claim 13, wherein a last price is used instead of the current ask price.

16. A computer program embodied in a computer readable medium for performing a sell-side trailing stop transaction comprising:
(a) a code segment for receiving a transaction request for an investment containing a target price, a stop price and a trail amount for an investment;
(b) a code segment for obtaining a current bid price for the investment;
(c) a code segment for determining whether the current bid price is greater than or equal to the target price;
(d) a code segment for whenever the current bid price is greater than or equal to the target price, setting the stop price equal to the current bid price minus the trail amount and repeating steps (b) through (e); and
(e) a code segment for whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price.

17. The computer program as recited in claim 16, wherein the stop price is not set equal to the current bid price minus the trail amount when the current bid price minus the trail amount is greater than the stop price.

18. The computer program as recited in claim 16, wherein a last price is used instead of the current bid price.

19. A computer program embodied in a computer readable medium for performing a buy-side trailing stop transaction comprising:
(a) a code segment for receiving a transaction request for an investment containing a target price, a stop price and a trail amount for an investment;
(b) a code segment for obtaining a current ask price for the investment;
(c) a code segment for determining whether the current ask price is less than or equal to the target price;
(d) a code segment for whenever the current ask price is less than or equal to the target price, setting the stop price equal to the current ask price plus the trail amount and repeating steps (b) through (e); and
(e) a code segment for whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price.

20. The computer program as recited in claim 19, wherein the stop price is not set equal to the current ask price plus the trail amount when the current ask price plus the trail amount is less than the stop price.

21. The computer program as recited in claim 19, wherein a last price is used instead of the current ask price.

22. An apparatus for performing a sell-side trailing stop transaction comprising:
one or more market communication interfaces; and
a processor communicably coupled to the one or more market communications interface, the processor performing the following steps:
(a) receiving a transaction request for an investment containing a target price, a stop price and a trail amount for an investment;
(b) obtaining a current bid price for the investment;
(c) determining whether the current bid price is greater than or equal to the target price;
(d) whenever the current bid price is greater than or equal to the target price, setting the stop price equal to the current bid price minus the trail amount and repeating steps (b) through (e); and
(e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price.

23. The apparatus as recited in claim 22, wherein the stop price is not set equal to the current bid price minus the trail amount when the current bid price minus the trail amount is greater than the stop price.

24. The apparatus as recited in claim 22, wherein a last price is used instead of the current bid price.

25. The apparatus as recited in claim 22, further comprising one or more client communication interfaces communicably coupled to the processor.

26. The apparatus as recited in claim 22, further comprising a management and security system communicably coupled to the processor.

27. The apparatus as recited in claim 22, further comprising one or more input/output devices communicably coupled to the processor.

28. The apparatus as recited in claim 22, further comprising a data storage unit communicably coupled to the processor.

29. The apparatus as recited in claim 22, further comprising a local area network or parallel processing interface communicably coupled to the processor.

30. The apparatus as recited in claim 22, wherein the investment comprises a stock, a bond, a mutual fund, a commodity, an option or a currency pair.

31. The apparatus as recited in claim 22, wherein the transaction request comprises one or more transaction messages.

32. The apparatus as recited in claim 22, wherein the transaction request is created from one or more inputs provided by the client.

33. The apparatus as recited in claim 32, wherein the one or more inputs include data from fill-in fields, point-and-click operations, drop-down menus, verbal commands, macros or any combination thereof.

34. The apparatus as recited in claim 22, wherein the processor further performs the step of validating the transaction request.

35. The apparatus as recited in claim 22, wherein the processor further performs the step of sending a notification that the market or limit sell order has been submitted to the client originating the transaction request via the first communications interface.

36. The apparatus as recited in claim 22, wherein the processor further performs the step of waiting for a specified period of time before repeating steps (b) through (e).

37. The apparatus as recited in claim 22, wherein the transaction request further comprises a quantity of the investment, account information or client information.

38. An apparatus for performing a buy-side trailing stop transaction comprising:
one or more market communication interfaces; and
a processor communicably coupled to the first communications interface, the processor performing the following steps:
(a) receiving a transaction request for an investment containing a target price, a stop price and a trail amount for an investment;
(b) obtaining a current ask price for the investment;
(c) determining whether the current ask price is less than or equal to the target price;
(d) whenever the current ask price is less than or equal to the target price, setting the stop price equal to the current ask price plus the trail amount and repeating steps (b) through (e); and
(e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price.

39. The apparatus as recited in claim 38, wherein the stop price is not set equal to the current ask price plus the trail amount when the current ask price plus the trail amount is less than the stop price.

40. The apparatus as recited in claim 38, wherein a last price is used instead of the current ask price.

41. A system for performing a sell-side trailing stop transaction comprising:
one or more markets;
one or more networks;
one or more market communication interfaces communicably coupled to one or more markets via the one or more networks; and
a processor communicably coupled to the one or more market communication interfaces, the processor performing the following steps:
(a) receiving a transaction request for an investment containing a target price, a stop price and a trail amount for an investment;
(b) obtaining a current bid price for the investment;
(c) determining whether the current bid price is greater than or equal to the target price;
(d) whenever the current bid price is greater than or equal to the target price, setting the stop price equal to the current bid price minus the trail amount and repeating steps (b) through (e); and
(e) whenever the current bid price is less than the target price, determining whether the current bid price is less than or equal to the stop price, repeating steps (b) through (e) whenever the current bid price is greater than the stop price, and submitting a market or limit sell order whenever the current bid price is less than or equal to the stop price.

42. The system as recited in claim 41, wherein the stop price is not set equal to the current bid price minus the trail amount when the current bid price minus the trail amount is greater than the stop price.

43. The system as recited in claim 41, wherein a last price is used instead of the current bid price.

44. The system as recited in claim 41, further comprising:
one or more clients; and
one or more client communication interfaces communicably coupled to the processor and the one or more clients via the one or more networks.

45. A system for performing a buy-side trailing stop transaction comprising:
one or more markets;
one or more networks;
one or more market communication interfaces communicably coupled to one or more markets via the one or more networks; and
a processor communicably coupled to the one or more market communication interfaces, the processor performing the following steps:
(a) receiving a transaction request for an investment containing a target price, a stop price and a trail amount for an investment;
(b) obtaining a current ask price for the investment;
(c) determining whether the current ask price is less than or equal to the target price;
(d) whenever the current ask price is less than or equal to the target price, setting the stop price equal to the current ask price plus the trail amount and repeating steps (b) through (e); and
(e) whenever the current ask price is greater than the target price, determining whether the current ask price is greater than or equal to the stop price, repeating steps (b) through (e) whenever the current ask price is less than the stop price, and submitting a market or limit buy order whenever the current ask price is greater than or equal to the stop price.

46. The system as recited in claim 45, wherein the stop price is not set equal to the current ask price plus the trail amount when the current ask price plus the trail amount is less than the stop price.

47. The system as recited in claim 45, wherein a last price is used instead of the current ask price.

48. The system as recited in claim 45, further comprising:
one or more clients; and
one or more client communication interfaces communicably coupled to the processor and the one or more clients via the one or more networks.
